(19) United States
(12) Patent Application Publication
(10) Pub. No.: US 2022/0030206 A1
(43) Pub. Date: Jan. 27, 2022

(54) INFORMATION PROCESSING APPARATUS, INFORMATION PROCESSING METHOD, PROGRAM, AND PROJECTION SYSTEM

(71) Applicant: SONY GROUP CORPORATION, TOKYO (JP)

(72) Inventors: TAKUYA IKEDA, TOKYO (JP); KENTARO IDA, TOKYO (JP)

(21) Appl. No.: 17/309,396

(22) PCT Filed: Nov. 12, 2019
(86) PCT No.: PCT/JP2019/044323

§ 371 Date: May 25, 2021

(51) Int. Cl. H04N 9/31

(52) U.S. Cl. CPC H04N 9/3185

(57) ABSTRACT

[Object] An information processing apparatus according to the present technology includes a control unit. The control unit estimates a self-position of a projection apparatus in a real space in accordance with a movement of the projection apparatus and performs projection control of the projection apparatus on the basis of at least the estimated self-position.

### TECHNICAL FIELD

The present technology relates to an information processing apparatus, an information processing method, a program, and a projection system. Specifically, the present technology relates to a technology of applying a feature quantity map depending on an environment in a real space to geometric correction.

### BACKGROUND ART

In recent years, a projector capable of projecting a video to an arbitrary location by freely changing a projection direction has been disclosed (e.g., see Patent Literature 1). As such a projector, there is known a projector that can be carried by a user to various locations (e.g., see Patent Literature 2).

### CITATION LIST

### Patent Literature

Patent Literature 1: Japanese Patent Application Laid-open No. 2008-203426

Patent Literature 2: Japanese Patent Application Laid-open No. 2005-164930

### DISCLOSURE OF INVENTION

### Technical Problem

When driving such a projector, the projected video sometimes contains a distortion depending on a state of a projection plane on which the video is projected. However, in order to overcome such distortions, it is, for example, necessary to correct each distortion in accordance with the state of the projection plane on which the video is projected. Thus, it takes too much time to project the distortion-corrected video on the projection plane.

In view of the above-mentioned circumstances, the present technology has been made to enable a video depending on a projection environment to be projected without time constraints.

### Solution to Problem

In order to achieve the above-mentioned object, an information processing apparatus according to an embodiment of the present technology includes a control unit.

The control unit estimates a self-position of a projection apparatus in a real space in accordance with a movement of the projection apparatus and performs projection control of the projection apparatus on the basis of at least the estimated self-position.

Here, the “real space” refers to general spaces that physically exist and are capable of housing the projection apparatus. For example, examples of the “real space” include an indoor space such as a living room, a kitchen, and a bedroom and an space in a vehicle. Moreover, the “self-position” means at least relative position and attitude of the projection apparatus with respect to the real space in which the projection apparatus is set.

The control unit may acquire space information of the real space and perform the projection control on the basis of the space information and the estimated self-position.

The control unit may estimate the self-position of the projection apparatus on the basis of the space information.

The control unit may calculate a feature quantity of the real space on the basis of the space information and estimate the self-position of the projection apparatus on the basis of the feature quantity.

The control unit may perform the projection control on the basis of the feature quantity and the estimated self-position.

The control unit may identify a type of the real space on the basis of the space information.

The control unit may calculate the feature quantity of the real space on the basis of the space information and identify the real space on the basis of the feature quantity.

The control unit may calculate a reprojection error on the basis of the feature quantity and identify the real space in a case where the reprojection error is equal to or less than a predetermined threshold.

The control unit may newly acquire the space information of the real space by scanning the real space by the projection apparatus in a case where the type of the real space can be identified. It should be noted that the “scanning” refers to general operations of scanning the inside of the real space in which the projection apparatus is set.

The control unit may estimate the self-position of the projection apparatus on the basis of the newly acquired space information.

The control unit may perform the projection control on the basis of the newly acquired space information and the estimated self-position.

The control unit may acquire shape data regarding a three-dimensional shape of the real space and calculate the feature quantity on the basis of at least the shape data.

The control unit may calculate a two-dimensional feature quantity, a three-dimensional feature quantity, or a space size of the real space as the feature quantity.

The control unit may perform a standby mode to identify the type of the real space and estimate the self-position of the projection apparatus.

The control unit may include generates a geometrically corrected video as the projection control.

The control unit may cause the projection apparatus to project the geometrically corrected video to a position specified by a user.

In order to achieve the above-mentioned object, an information processing method of an information processing apparatus according to an embodiment of the present technology includes estimating a self-position of a projection apparatus in a real space in accordance with a movement of the projection apparatus.

Projection control of the projection apparatus is performed on the basis of at least the estimated self-position.

In order to achieve the above-mentioned object, a program according to an embodiment of the present technology causes an information processing apparatus to execute the following steps.

A step of estimating a self-position of a projection apparatus in a real space in accordance with a movement of the projection apparatus.

A step of performing projection control of the projection apparatus on the basis of at least the estimated self-position.

The above program may be recorded on a computer-readable recording medium.

In order to achieve the above-mentioned object, a projection system according to an embodiment of the present technology includes a projection apparatus and an information processing apparatus.

The projection apparatus projects a video to a projection target.

The information processing apparatus includes a control unit.

The control unit estimates a self-position of a projection apparatus in a real space in accordance with a movement of the projection apparatus and performs projection control of the projection apparatus on the basis of at least the estimated self-position.

### BRIEF DESCRIPTION OF DRAWINGS

FIG. 1 A schematic diagram schematically showing a configuration example of a projection system according to the present technology.

FIG. 2 A block diagram showing a configuration example of the projection system.

FIG. 3 A diagram showing a hardware configuration example of the information processing apparatus according to the present technology.

FIG. 4 A schematic diagram showing an overall processing flow of the information processing apparatus.

FIG. 5 A diagram showing an example of feedback to a user by a video.

FIG. 6 A flowchart showing an overall processing flow of the information processing apparatus.

FIG. 7 A flowchart showing the details of a process of the information processing method.

FIG. 8 A schematic diagram of a real space in which a projection apparatus according to the present technology is set, which is a diagram illustrating feature points of the real space.

FIG. 9 A schematic diagram of the real space in which the projection apparatus is set.

FIG. 10 A diagram showing states before and after construction of a feature quantity map as well as an example in which the feature quantity map is visualized.

FIG. 11 A flowchart showing the details of a process of the information processing method.

FIG. 12 A conceptual diagram for describing estimation of the self-position of the projection apparatus.

FIG. 13 A flowchart showing the details of a process of the information processing method.

FIG. 14 A diagram showing an example in which the geometrically corrected video is projected.

FIG. 15 A diagram showing an example in which the geometrically corrected video is projected.

FIG. 16 A diagram showing an example in which the geometrically corrected video is projected.

FIG. 17 A diagram showing two-dimensional and three-dimensional coordinate positions pointed by the user via an input device.

FIG. 18 A flowchart showing an information processing method according to another embodiment of the present technology.

FIG. 19 A diagram showing an example of a real space ID list.

### MODE(S) FOR CARRYING OUT THE INVENTION

Hereinafter, embodiments of the present technology will be described with reference to the drawings. The embodiments of the present technology will be described in the following order.

1. First Embodiment

1-1. Overall Configuration

### 1-1-1. Hardware Configuration of Projection System

### 1-1-2. Configuration of Information Processing Apparatus

### (1-1-2-1. Hardware Configuration of Information Processing Apparatus)

### (1-1-2-2. Function Configuration of Information Processing Apparatus)

### 1-2. Information Processing Method

### 1-2-1. Outline of Information Processing Method

### 1-2-2. Details of Information Processing Method

### 1-3. Actions and Effects

2. Another Embodiment

3. Modified Examples

4. Supplement

### 1.) First Embodiment

The projection system according to this embodiment is a system including a (portable) drive-type projector (hereinafter, referred to as drive-type PJ) whose setting position can be changed by a user, in which the projector is driven in accordance with a position pointed by the user via a pointing device and a geometrically corrected video is projected onto the position in real time. The details of the projection system of the present technology will be described below.

1-1.) Overall Configuration

1-1-1.) Hardware Configuration of Projection System

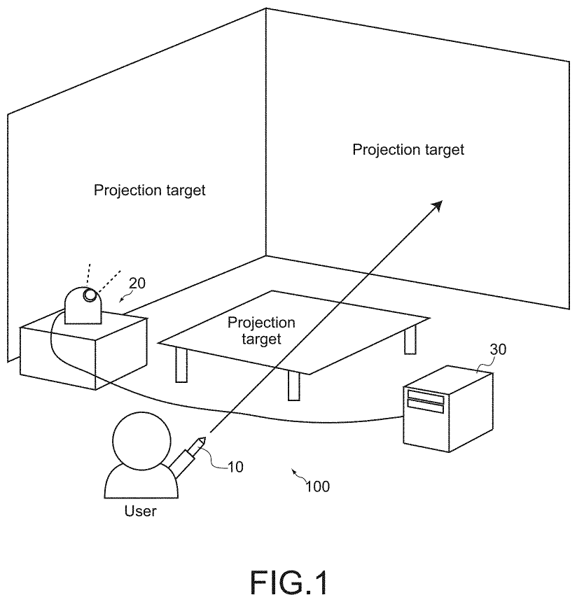

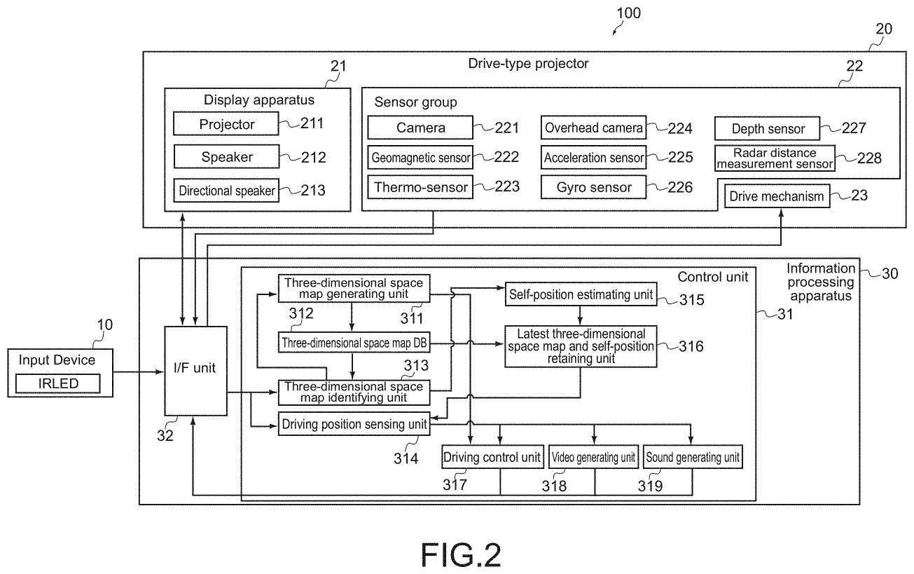

FIG. 1 is a schematic diagram showing a configuration example of a projection system 100 according to this embodiment in a simplified manner, and FIG. 2 is a block diagram showing a configuration example of the projection system 100. The projection system 100 includes an input device 10, a drive-type PJ 20, and an information processing apparatus 30 as shown in FIGS. 1 and 2. The drive-type PJ 20 is an example of a “projection apparatus” in the scope of claims.

[Input Device]

The input device 10 is an arbitrary input device held by the user, and is typically a hand-held pointing device in which a highly directional infrared light-emitting diode (IRLED) is mounted on a tip end of a casing, though not limited thereto.

For example, the input device 10 may include a communication module configured to be communicable with the information processing apparatus 30 and a sensor capable of detecting its own movement such as a geomagnetic sensor, a gyro sensor, and an acceleration sensor. With this configuration, it is possible to save power and manage the status of the user by identifying what state the user is using the input device 10 in, for example.

Alternatively, the input device 10 may be, for example, a smartphone, a tablet terminal, or the like. In this case, the user may operate a graphical user interface (GUI) such as up, down, left, and right keys displayed on the display screen to move the drive-type PJ 20 or may display an omni-directional image on the display screen to specify a location where the drive-type PJ 20 is to be driven.

In this embodiment, for example, in a case where the user wishes to project a video at a desired position on a projection target, the user directs the input device 10 to the projection target to point the position. Then, the pointed position is detected by, for example, an overhead camera 224 built in the drive-type PJ 10. Accordingly, a projector 211 (display apparatus 21) is driven and the video is projected to the position pointed by the user.

It should be noted that in this embodiment, the position pointed by the user with the input device 10 is typically detected when projecting the video onto the projection target, though not limited thereto. Alternatively, for example, a touch with the user's hand or finger, a move such as pointing with a finger, or the like may be detected by the overhead camera 224 and the video may be projected to a position desired by the user, which is specified by the move. Moreover, in this embodiment, the projection target is typically a wall, a floor, a ceiling, or the like in a real space in which the drive-type PJ 20 is set, though not limited thereto.

[Drive-Type PJ]

The drive-type PJ 20 includes the display apparatus 21, a sensor group 22, and a drive mechanism 23 as shown in FIG. 2. The display apparatus 21 is an apparatus that projects a video on an arbitrary projection target in such a manner that the drive mechanism 23 controls the projection direction.

(Display Device)

The display apparatus 21 according to this embodiment is typically the projector 211 or the like that projects a video to a position specified by the user, though not limited thereto. Alternatively, the display apparatus 21 according to this embodiment may further include a speaker 212 that feeds sound back to the user, for example. In this case, the speaker 212 may be a typical speaker such as a cone-type speaker or a speaker such as a dome-type speaker, a horn-type speaker, a ribbon-type speaker, a sealing-type speaker, and a bass reflex-type speaker.

Alternatively, the display apparatus 21 may include a directional speaker 213 such as a highly directional ultrasonic speaker instead of or in addition to the speaker 212, and the directional speaker 213 may be arranged coaxially with the projection direction of the projector 211.

(Sensor Group)

The sensor group 22 includes a camera 221, a geomagnetic sensor 222, a thermo-sensor 223, the overhead camera 224, an acceleration sensor 225, a gyro sensor 226, a depth sensor 227, and a radar distance measurement sensor 228 as shown in FIG. 2.

The camera 221 is a fisheye camera configured to be capable of capturing an image inside the real space including the projection target. The camera 221 is typically a color camera that generates, for example, RGB images by capturing images in real space, though not limited thereto. Alternatively, the camera 221 may be, for example, a monochrome camera.

It should be noted that in this specification, the “real space” is a physically existing space capable of housing at least the drive-type PJ 20, and the same applies to the following descriptions.

The geomagnetic sensor 222 is configured to be capable of detecting the magnitude and direction of the magnetic field inside the real space in which the drive-type PJ 20 is set, and, for example, is utilized when detecting the direction of the drive-type PJ 20 in the real space. A two-axis-type sensor or a three-axis-type sensor may be employed as the geomagnetic sensor 222 and any type of sensor can be employed. Moreover, the geomagnetic sensor 222 may be, for example, a Hall sensor, a magneto resistance (MR) sensor, a magneto impedance (MI) sensor, or the like.

The thermo-sensor 223 is configured to be capable of detecting a projection target pointed through the input device 10 or a temperature change of the projection target touched by the user's hand or finger, for example. A contactless sensor such as a pyroelectric temperature sensor, a thermopile, and a radiation thermometer or a contact sensor such as a thermocouple, a resistance thermometer, a thermistor, an IC temperature sensor, and an alcohol thermometer may be employed as the thermo-sensor 223, and any type of sensor can be employed. It should be noted that the thermo-sensor 223 may be omitted as necessary.

The overhead camera 224 includes, for example, a plurality of wide-angle cameras capable of observing infrared light in a wide field of view in the real space in which the drive-type PJ 20 is set, and detects a position at which the projection target is pointed through the input device 10.

The acceleration sensor 225 is configured to be capable of measuring the acceleration of the drive-type PJ 20 in a case where the drive-type PJ 20 is moved, for example, and detects various movements such as inclination, vibration, and the like of the drive-type PJ 20. A piezoelectric acceleration sensor, a servo-type acceleration sensor, a strain-type acceleration sensor, a semiconductor-type acceleration sensor, or the like may be employed as the acceleration sensor 225, and any type of sensor can be employed.

The gyro sensor 226 is an inertial sensor configured to be capable of measuring, for example, how much the rotational angle of the drive-type PJ 20 is changing per unit time when the drive-type PJ 20 is moved, i.e., the angular velocity at which the drive-type PJ 20 is rotating. A mechanical, optical, fluid-type, or vibration-type gyro sensor may be employed as the gyro sensor 226, for example, and any type of sensor can be employed.

The depth sensor 227 acquires three-dimensional information of the real space drive-type PJ 20 is set and is configured to be capable of measuring a three-dimensional shape of the real space such as a depth (distance) from the drive-type PJ 20 to the projection target or the like, for example. The depth sensor 227 is, for example, a time of flight (ToF)-type infrared light depth sensor, though not limited thereto. Alternatively, another type of sensor such as an RGB depth sensor, for example, may be employed as the depth sensor 227.

The radar distance measurement sensor 228 is a sensor that measures a distance from the drive-type PJ 20 to the projection object by emitting a radio wave toward the projection target and measuring the reflected wave, and is configured to be capable of measuring the dimension of the real space in which the drive-type PJ is set, for example.

The projection system 100 measures the three-dimensional shape of the real space including the projection target or recognizes this real space on the basis of the outputs of the camera 221 and the depth sensor 227. In addition, the projection system 100 estimates the self-position of the drive-type PJ 20 in real space on the basis of the outputs of the camera 221 and the depth sensor 227.

It should be noted that in this embodiment, the “self-position” of the drive-type PJ 20 means at least relative position and attitude of the drive-type PJ 20 with respect to the real space in which the drive-type PJ 20 is set, and the meaning does not change in the following description.

(Drive Mechanism)

The drive mechanism 23 is a mechanism that drives the projector 211 (display apparatus 21) and the sensor group 22. Specifically, the drive mechanism 23 is configured to be capable of changing the projection direction of the projector 211 and the orientations and sensing positions of the various sensors constituting the sensor group 22. This change is performed by changing the orientation of a mirror (not shown) mounted on the drive mechanism 23, for example.

The drive mechanism 23 according to this embodiment is typically a pan-tilt mechanism capable of two-axis driving, though not limited thereto. The drive mechanism 23 may be configured not only to be capable of changing the direction of projection of the projector 211 or the like, but also to be capable of moving the projector 211 (display apparatus 21) in accordance therewith, for example.

[Information Processing Apparatus]

The information processing apparatus 30 generates a video signal and an audio signal and outputs these signals to the display apparatus 21 on the basis of the outputs from the sensor group 22 and the input device 10. Moreover, the information processing apparatus 30 controls the drive mechanism 23 on the basis of position information such as the position pointed through the input device 10. Hereinafter, the configuration of the information processing apparatus 30 will be described.

1-1-2.) Configuration of Information Processing Apparatus

1-1-2-1.) Hardware Configuration of Information Processing Apparatus

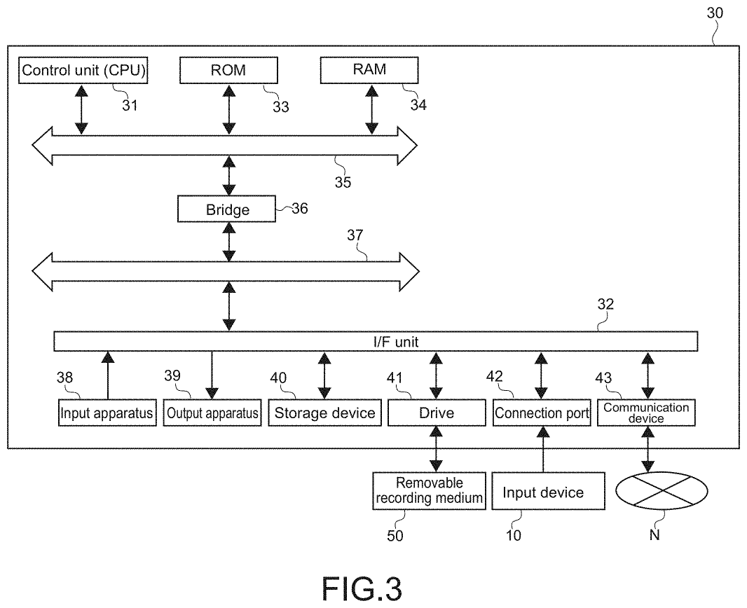

FIG. 3 is a block diagram showing an example of a hardware configuration of the information processing apparatus 30. The information processing apparatus 30 includes a control unit 31 (central processing unit (CPU)), a read only memory (ROM) 33, and a random access memory (RAM) 34. The CPU is an example of the “control unit” in the scope of claims.

Moreover, the information processing apparatus 30 may include a host bus 35, a bridge 36, an external bus 37, an I/F unit 32, an input apparatus 38, an output apparatus 39, a storage apparatus 40, a drive 41, a connection port 42, and a communication device 43.

Moreover, the information processing apparatus 30 may include processing circuits such as a digital signal processor (DSP), an application specific integrated circuit (ASIC), and a field-programmable gate array (FPGA) instead of or in addition to the control unit 31 (CPU).

The control unit 31 (CPU) functions as an arithmetic processing apparatus and a control apparatus, and controls the overall operation of the information processing apparatus 30 or a part thereof in accordance with various programs recorded on a ROM 33, a RAM 34, the storage apparatus 40, or a removable recording medium 50.

The ROM 33 stores such programs and arithmetic parameters to be used by the control unit 31 (CPU). The RAM 34 primarily stores a program to be used in executing the control unit 31 (CPU) and parameters or the like that change as appropriate in executing it. The control unit 31 (CPU), the ROM 33, and the RAM 34 are interconnected by the host bus 35 formed by an internal bus such as a CPU bus. In addition, the host bus 35 is connected via the bridge 36 to the external bus 37 such as a peripheral component interconnect/interface (PCI) bus.

The input apparatus 38 is an apparatus operated by the user, such as a mouse, a keyboard, a touch panel, a button, a switch, and a lever, for example. The input apparatus 38 may be, for example, a remote control apparatus using infrared rays or other radio waves or may be an externally connected device compatible with the operation of the information processing apparatus 30. The input apparatus 38 includes an input control circuit that generates an input signal on the basis of information input by the user and outputs the input signal to the control unit 31 (CPU). By operating the input apparatus 38, the user inputs various types of data to the information processing apparatus 30 or instructs a processing operation.

The output apparatus 39 is configured as an apparatus capable of notifying the user of acquired information using a sense of vision, a sense of hearing, a sense of touch, or the like. The output apparatus 39 can be, for example, a display apparatus such as a liquid crystal display (LCD) and an organic electro-luminescence (EL) display, an audio output apparatus such as a speaker and a headphone, a vibrator, or the like. The output apparatus 39 outputs the result acquired by the processing of the information processing apparatus 30 as a video such as a text and an image, audio such as voice and sound, vibration, or the like.

The storage apparatus 40 is a data storage apparatus configured as an example of a storage unit of the information processing apparatus 30. The storage apparatus 40 includes, for example, a magnetic storage device such as a hard disk drive (HDD), a semiconductor storage device, an optical storage device, a magneto-optical storage device, or the like. The storage apparatus 40 stores, for example, a program and various types of data to be executed by the control unit 31 (CPU), and various types of data acquired from the outside, and the like.

The drive 41 is a reader/writer for the removable recording medium 50 such as a magnetic disk, an optical disc, a magneto-optical disc, and a semiconductor memory, and is built in or externally attached to the information processing apparatus 30. The drive 41 reads out the information recorded on the removable recording medium 50 and outputs the information to the RAM 34. Moreover, the drive 41 writes a record in the mounted removable recording medium 50.

The connection port 42 is a port for connecting the device to the information processing apparatus 30. The connection port 42 may be, for example, a universal serial bus (USB) port, an IEEE1394 port, a small computer system interface (SCSI) port, or the like. Alternatively, the connection port 42 may be an RS-232C port, an optical audio terminal, a high-definition multimedia interface (HDMI) (registered trademark) port, or the like. By connecting the input device 10 to the connection port 42, various types of data are output from the input device 10 to the information processing apparatus 30.

The communication apparatus 43 is, for example, a communication interface including a communication device for connecting to a communication network N. The communication apparatus 43 may be, for example, a communication card for a local area network (LAN), Bluetooth (registered trademark), Wi-Fi, or a wireless USB (WUSB).

Alternatively, the communication apparatus 43 may be a router for optical communication, a router for an asymmetric digital subscriber line (ADSL), a modem for various types of communication, or the like. The communication device 43 sends and receives a signal and the like to and from the Internet or other communication devices by using a predetermined protocol such as TCP/IP. Moreover, the communication network N connected to the communication device 43 is a network connected by wire or wireless, and may include, for example, the Internet, a home LAN, infrared communication, radio wave communication, satellite communication, or the like.

1-1-2-2.) Functional Configuration of Information Processing Apparatus

The information processing apparatus 30 (control unit 31) functionally includes a three-dimensional space map generating unit 311, a three-dimensional space map DB 312, a three-dimensional space map identifying unit 313, a driving position sensing unit 314, a self-position estimating unit 315, a latest three-dimensional space map and self-position retaining unit 316, a driving control unit 317, an video generating unit 318, and a sound generating unit 319.

The three-dimensional space map generating unit 311 constructs a three-dimensional shape and a feature quantity map of the real space in which the drive-type PJ 20 is set. The three-dimensional space map DB 312 stores this feature quantity map. At this time, in a case where the feature quantity map of the real space which is the same as the real space in which the feature quantity map is constructed is stored in the three-dimensional space map DB 312, the feature quantity map is updated, and the updated feature quantity map is output to the latest three-dimensional space map and self-position retaining unit 316.

The three-dimensional space map identifying unit 313 identifies the real space in which the drive-type PJ 20 is set by referring to the feature quantity map stored in the three-dimensional space map DB 312 in a case where the movement of the drive-type PJ 20 is detected by moving the setting position of the drive-type PJ 20 by the user or the like. It should be noted that the processing of identifying the real space may be performed in a case where the drive-type PJ 20 is started for the first time or the like.

The self-position estimating unit 315 estimates the self-position of the drive-type PJ 20 in the real space identified by the three-dimensional space map identifying unit 313. Information on the estimated self-position of the drive-type PJ 20 is output to the latest three-dimensional space map and self-position retaining unit 316.

The latest three-dimensional space map and self-position retaining unit 316 acquires and retains the information output from the self-position estimating unit 315 and the feature quantity map (feature quantity map of the real space in which the drive-type PJ 20 is currently set) output from the three-dimensional space map DB 312. Then, such information is output to the driving position sensing unit 314.

The drive position sensing unit 314 calculates the position pointed through the input device 10 on the basis of the outputs from the sensor group 22 (overhead camera 224), and outputs the calculation result to the driving control unit 317. Accordingly, the projection position of the projector 211 is controlled to the position pointed through the input device 10. Moreover, the driving position sensing unit 314 outputs the information acquired from the latest three-dimensional space map and self-position retaining unit 316 to the driving control unit 317, the video generating unit 318, and the sound generating unit 319.

The driving control unit 317 controls the drive mechanism 23 on the basis of the outputs of the three-dimensional space map generating unit 311 and the drive position sensing unit 314. The sound generating unit 319 generates an audio signal on the basis of the output of the driving position sensing unit 314 and outputs the signal to the speaker 212 and the directional speaker 213.

The video generating unit 318 generates a video signal on the basis of an output from the driving position sensing unit 314 and outputs the signal to the projector 211 (display apparatus 21). At this time, the video generated by the video generating unit 318 becomes a video geometrically corrected in accordance with a projection plane of an arbitrary projection target.

1-2.) Information Processing Method

1-2-1.) Outline of Information Processing Method

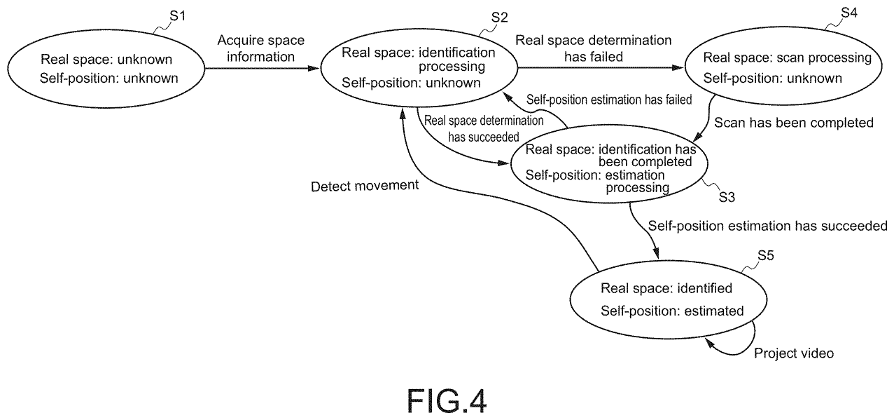

FIG. 4 is a schematic diagram showing a flow of the entire processing of the information processing apparatus 30, and is a diagram showing a processing flow from the start of the drive-type PJ 20 to the projection of the video onto the arbitrary projection target. Hereinafter, an information processing method of the projection system 100 according to this embodiment will be roughly described with reference to FIG. 4.

First, the drive-type PJ 20 is started. At this time, an arbitrary real space in which the drive-type PJ 20 is set is not recognized (identified), and the self-position of the drive-type PJ 20 in the real space is unknown (Step S1).

Next, in a case where the movement of the drive-type PJ 20 is detected, the information processing apparatus 30 acquires space information of the real space in which the drive-type PJ 20 is set, and performs identification processing of identifying the type, which real space the real space in which the drive-type PJ 20 is set is (e.g., whether the real space is a living room, a kitchen, or a bedroom, or the like) on the basis of the space information (Step S2).

Next, in a case where the type of the real space in which the drive-type PJ 20 is set is identified as a result of the identification processing, the information processing apparatus 30 estimates the self-position of the drive-type PJ 20 in the real space on the basis of the acquired space information of the real space (Step S3).

On the other hand, in a case where the type of the real space in which the drive-type PJ 20 is set is not determined as a result of the identification processing, the information processing apparatus 30 performs scanning processing of newly acquiring the space information of the real space in which the drive-type PJ 20 is set (Step S4). In operation S3, the information processing apparatus 30 estimates the self-position of the drive-type PJ 20 on the basis of the space information obtained as a result of the scanning processing (Step S3).

Here, in the previous Step S3, in a case where the information processing apparatus 30 is capable of estimating the self-position of the drive-type PJ 20, the information processing apparatus 30 performs the projection control on the basis of the space information of the acquired real space and the estimated self-position of the drive-type PJ 20, and the processed video is projected on the projection target (Step S5). On the other hand, in a case where the self-position of the drive-type PJ 20 cannot be estimated, the information processing apparatus 30 performs the previous Step S2 again.

Next, in a case where the movement of the drive-type JP 20 is detected by the user moving a setting location of the drive-type PJ 20 or the like, for example, the information processing apparatus 30 performs the previous Step S2 again at a setting location in which the drive-type PJ 20 is newly set.

The information processing apparatus 30 generally performs the information processing as described above. That is, the information processing apparatus 30 according to this embodiment detects the movement of the drive-type PJ 20 and performs identification of the real space and self-position estimation of the drive-type PJ 20 each time.

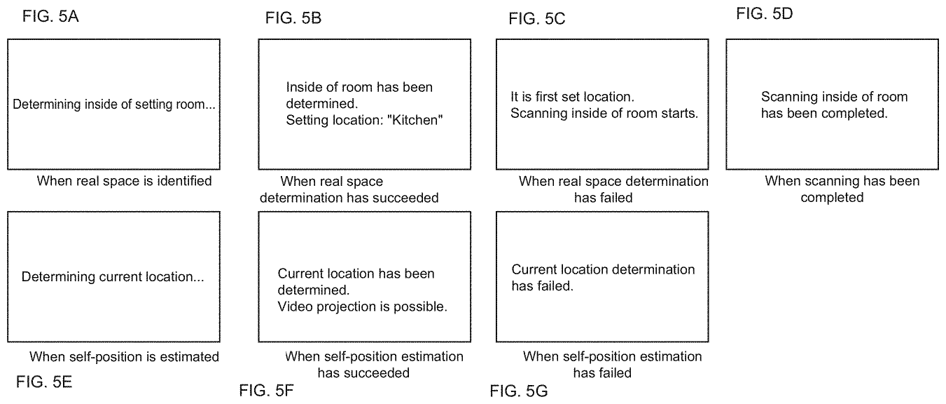

It should be noted that in this embodiment, the feedback to the user by a video, audio, or the like via the output apparatus 39 may be performed after the above Steps S2 to S4 are performed. FIG. 5 shows an example of such feedback to the user via the video. Alternatively, in this embodiment, as such feedback to the user, it may be left to the user to determine whether or not to perform the above Steps S3 and S4.

1-2-2.) Details of Information Processing Method

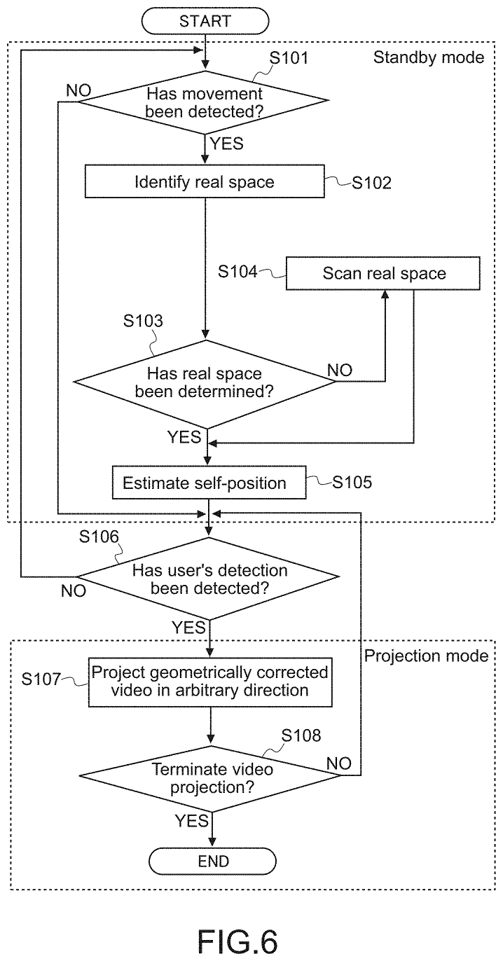

FIG. 6 is a flowchart showing an overall processing flow of the information processing apparatus 30. Here, the information processing apparatus 30 according to this embodiment performs a projection mode on which a video is projected onto a projection target in a case where the user's operation is detected after a standby mode on which an input from the user is waited. Hereinafter, the standby mode and the projection mode will be described in detail with reference to FIG. 6.

[Standby Mode]

(Step S101: Have Movement been Detected?)

First of all, in a case where the user changes the setting location of the drive-type PJ 20 in the real space or in a case where the user moves the drive-type PJ 20 to another real space, the geomagnetic sensor 222, the acceleration sensor 225, or the gyro sensor 226 detects the movement of the drive-type PJ 20 (Yes in Step S101), and the sensor data of these sensors is output to the control unit 31. On the other hand, in a case where the movement of the drive-type PJ 20 is not detected by the geomagnetic sensor 222, the acceleration sensor 225, or the gyro sensor 226 (NO in S101), whether or not there is an input via the input device 10 from the user is determined (Step S106).

It should be noted that in Step S101, the movement of the drive-type PJ 20 is typically detected by the geomagnetic sensor 222, the acceleration sensor 225, and the gyro sensor 226, though not limited thereto. Alternatively, the movement of the drive-type PJ 20 may be detected by an inertial measurement unit (IMU) sensor (inertial measuring device) in which the acceleration sensor 225 and the gyro sensor 226 are combined, for example.

(Step S102: Identify Real Space)

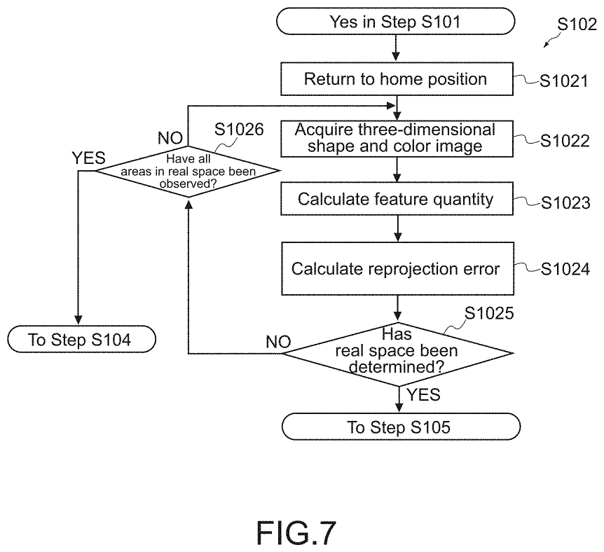

Next, the type of the real space in which the drive-type PJ 20 is set is identified. FIG. 7 is a flowchart showing the details of Step S102. Hereinafter, Step S102 will be described with reference to FIG. 7 as appropriate.

First, when the control unit 31 obtains the sensor data from the geomagnetic sensor 222, the acceleration sensor 225, or the gyro sensor 226, the drive-type PJ 20 (drive mechanism 23) returns to a home position (Step S1021). The home position refers to a state in which each of the pan angle and the tilt angle of the drive mechanism 23 employing a two-axis drivable pan-tilt mechanism is 0° (pan=0°, tilt=0°) for example. Next, the control unit 31 controls the projection direction of the projector 211 through the drive mechanism 23 in the real space in which the drive-type PJ 20 is set.

Accordingly, the projection direction of the projector 211 is set to a pre-registered direction, and a color image and a three-dimensional shape at an observation point in the projection direction are locally acquired (Step S1022). Then, the color image and shape data related to the three-dimensional shape are output to the control unit 31. At this time, the color image is captured by the camera 221 and the three-dimensional shape is measured by the depth sensor 227.

It should be noted that the registered projection direction depends on the registered drive angle (preset rotation angle) of the drive mechanism 23 that supports the projector 211, for example. Moreover, the color image and information related to the three-dimensional shape is an example of “space information” in the scope of claims.

Subsequently, the control unit 31 which has acquired the color image from the camera 221 and the information related to the three-dimensional shape from the depth sensor 227 calculates a feature quantity at the observed observation point on the basis of them (Step S1023).

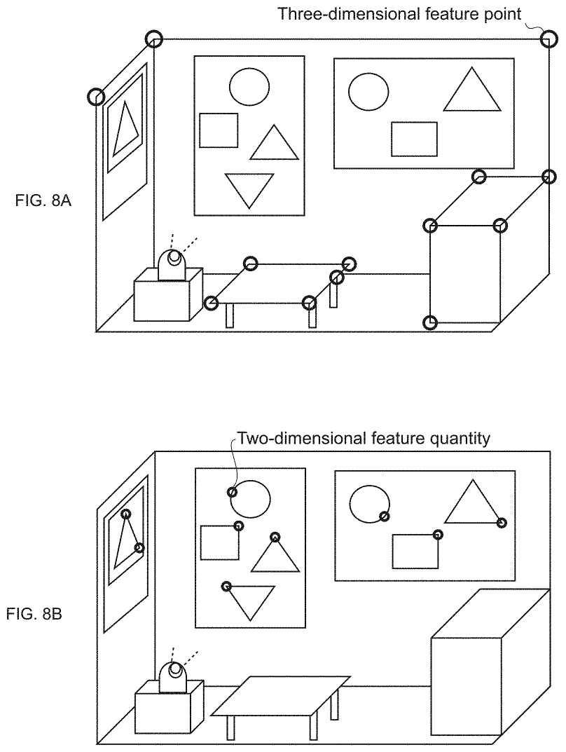

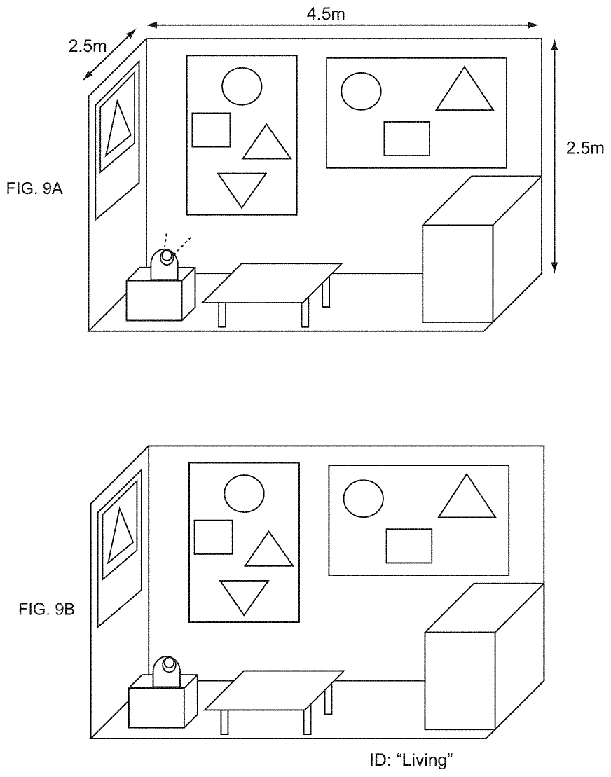

The feature quantity calculated in the Step S102 is, for example, a SHOT feature quantity calculated by signature of histograms of orientations (SHOT) to be described later. The SHOT feature quantity is defined by normal histograms of a group of peripheral points in a divided region around feature points (e.g., edge points) of an object existing in the real space. See Page 9 of Website 1 below for the details of the SHOT feature quantity. FIGS. 8 and 9 are schematic diagrams of the real space drive-type PJ is set and FIG. 8 is a diagram illustrating feature points of the real space.

Such three-dimensional feature quantities are calculated by, for example, a technique such as the SHOT, point feature histogram (PFH), and color signature of histograms of orientations (CSHOT).

Alternatively, the feature quantity may be calculated by a technique such as histogram of oriented normal vector (HONV), local surface patches (LSP), combination of curvatures and difference of normals (CCDoN), normal aligned radial feature (NARF), mesh histograms of oriented gradients (MHOG), and RoPS (rotational projection statistics).

Alternatively, the feature quantity may be calculated by a technique such as point pair feature (PPF), efficient ransac (ER), visibility context point pair feature (VC-PPF), or multimodal point pair feature (MPPF), point pair feature boundary-to-boundary or surface to boundary or line to line (PPF B2BorS2BorL2L), and vector pair matching (VPM).

It should be noted that for the details of the above techniques for calculating the three-dimensional feature quantity, see Website 1 below. 1: (http://isl.sist.chukyo-u.ac.jp/Archives/ViEW2014SpecialTalk-Hashimoto.pdf)

Alternatively, a two-dimensional feature quantity may be, for example, calculated as the feature quantity calculated in the Step S102. The two-dimensional feature quantity is, for example, a SIFT feature quantity calculated by scale invariant feature transform (SIFT) to be described later. The SIFT feature quantity is a feature quantity not depending on the scale (size, movement, rotation) of the two-dimensional image and is represented by a feature quantity vector of 128 dimensions calculated for each unit of a plurality of feature points detected from the two-dimensional image captured by the camera 221. For the details of the SIFT feature quantities, see Website 2 below.

2: (http://www.vision.cs.chubu.ac.jp/cvtutorial/PDF/02SIFTandMore.pdf)

The two-dimensional feature quantity is calculated by analyzing the two-dimensional image captured by the camera 221, for example, by a technique such as the SIFT, speed-up robust features (SURF), and rotation invariant fast feature (RIFF).

Alternatively, the two-dimensional feature quantity may be analyzed by a technique such as binary robust independent elementary features (BREIF), binary robust invariant scalable keypoints (BRISK), oriented FAST and rotated BRIEF (ORB), and a compact and real-time descriptors (CARD).

It should be noted that for the details of the above techniques for calculating the two-dimensional feature quantity, see Website 3 below.

3: (https://www.jstage.jst.go.jp/article/jjspe/77/12/77_1109/_pdf)

Moreover, in Step S102, on the basis of the color image and the information about the three-dimensional shape in the real space, which are obtained from the camera 221 and the depth sensor 227, the control unit 31 may calculate the size (maximum height, maximum width, and maximum depth, etc.) of the real space as the feature quantity (FIG. 9c).

Next, the control unit 31 compares the feature quantity calculated in the previous Step S102 with the feature quantity of the identified real space, which has already been stored in the three-dimensional space map DB 312 or the storage apparatus 40.

Specifically, the control unit 31 calculates a reprojection error (amount of deviation) between the feature quantity calculated on the basis of the local color image and the information about the local three-dimensional shape in the real space and the feature quantity (feature quantity map) of the identified real space that has already been stored (Step S1024), and determines whether or not the error is equal to or less than a predetermined threshold value.

Here, in a case where the reprojection error is equal to or less than the predetermined threshold value, the control unit 31 determines that the real space in which the drive-type PJ 20 is currently set is the previously identified real space referred to when calculating the reprojection error. That is, the type of the real space in which the drive-type PJ 20 is currently set is determined (Yes in Step S1025).

On the other hand, in a case where the reprojection error is larger than the predetermined threshold value, the control unit 31 determines that the feature quantity (feature quantity map) related to the real space in which the drive-type PJ 20 is currently set is not retained (No in Step S1025). Then, in a case where all areas in the real space have not yet been observed (No in Step S1026), the control unit 31 obtains the color image and information related to the three-dimensional shape of the observation point different from the observation point observed in the previous Step S1022. At this time, the observation point in the pre-registered projection direction is typically observed, though not limited thereto. Alternatively, the periphery of the observation point may be observed.

In this embodiment, the control unit 31 repeatedly performs Step S1022 to S1024 until the type of the real space in which the drive-type PJ 20 is currently set is determined.

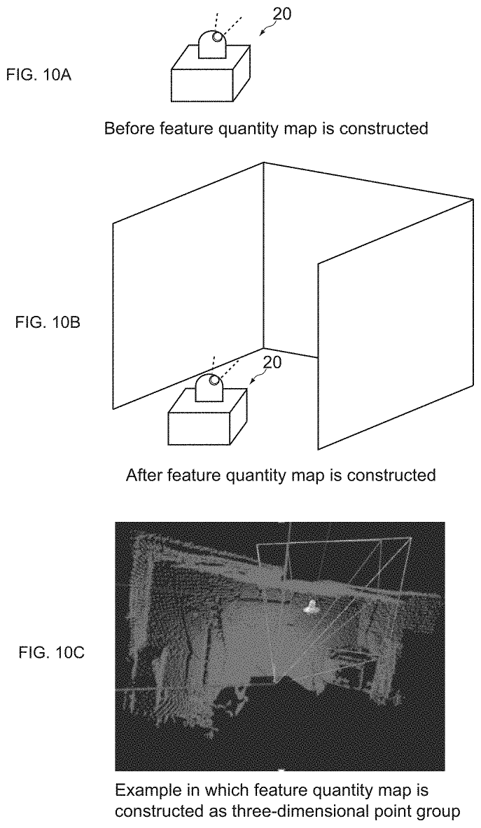

Then, the control unit 31 constructs and stores a feature quantity map (three-dimensional space map) of the real space in which the drive-type PJ 20 is currently set by integrating the feature quantity and the information of the three-dimensional shape of each of the plurality of observation points obtained in the process in which Steps S1022 to S1024 are repeated (FIG. 10a, FIG. 10b). At this time, the size of the real space may be calculated while constructing the feature quantity map.

Here, in a case where the feature quantity map of the real space identical to the real space in which the feature quantity map is constructed has already been stored, the feature quantity map is updated. In this embodiment, the feature quantity map is constructed as a three-dimensional point cloud map, for example. FIG. 10c shows an example of visualization of such a three-dimensional point cloud map.

On the other hand, in a case where the real space cannot be identified after all areas of the real space in which the drive-type PJ 20 is set are observed (Yes in Step S1026), the control unit 31 performs Step S104 to be described later.

(Step S104: Scan Real Space)

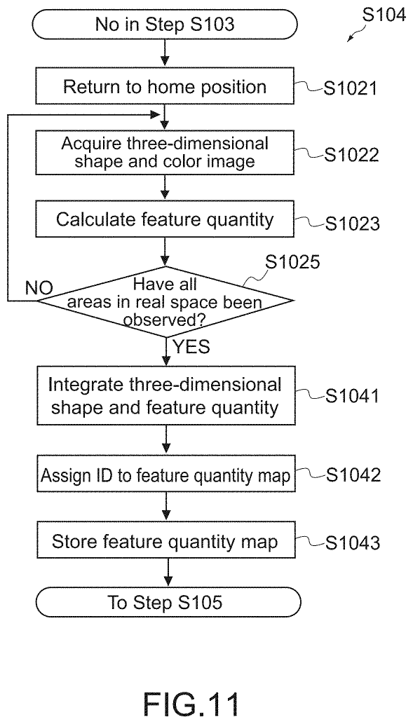

In Step S104, the projector 211 scans the inside of the real space in which the drive-type PJ 20 is set. FIG. 11 is a flowchart showing the details of Step S104. Hereinafter, Step S104 will be described with reference to FIG. 11 as appropriate. It should be noted that the same processes as those in Step S102 will be denoted by the same reference signs and descriptions thereof will be omitted.

In a case where all areas of the real space in which the drive-type PJ 20 is set are observed (Yes in Step S1025), the control unit 31 newly constructs a feature quantity map (three-dimensional space map) of the real space in which the drive-type PJ 20 is currently set by integrating the feature quantities and information of the three-dimensional shapes of the plurality of observation points (Step S1041), and stores the feature quantity map (FIG. 10).

Next, an ID is assigned to the feature quantity map constructed in the previous Step 1041 (Step S1042, FIG. 9d), and a new feature quantity map associated with this ID is stored in the control unit 31 (Step S1043).

(Step S105: Estimate Self-Position)

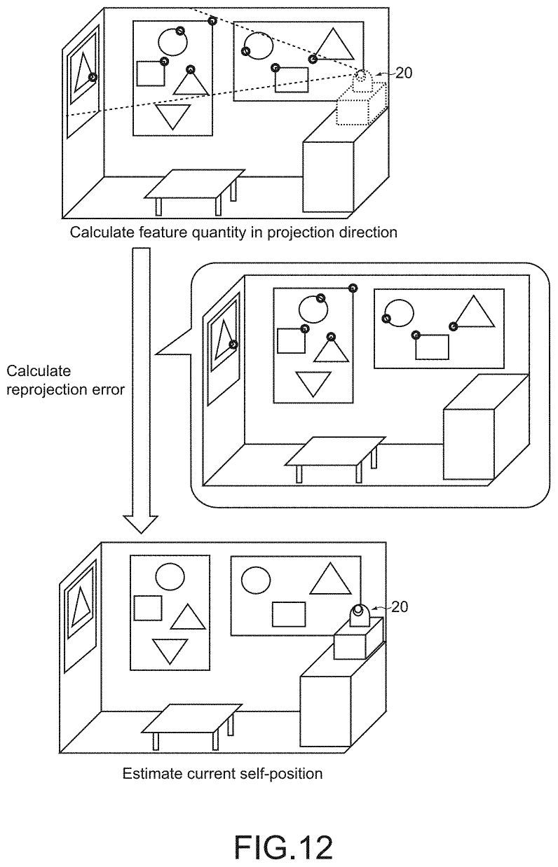

FIG. 12 is a conceptual diagram for describing the self-position estimation of the drive-type PJ. The control unit 31 estimates the self-position of the drive-type PJ 20 in the real space by simultaneous localization and mapping (SLAM) in a case where the real space in which the drive-type PJ 20 is currently set can be determined (Yes in Step S103) or after the real space is scanned (Step S104).

Specifically, the control unit 31 searches for a feature quantity map similar to the feature quantity map (feature quantity map of the real space in which the drive-type PJ 20 is currently set) constructed in the previous Step S102 (identify the real space) or Step S104 (scan the real space).

Next, the control unit 31 calculates a reprojection error (deviation amount) between the feature quantity map constructed in the previous Step S102 (identify the real space) or the Step S104 (scan the real space) and the feature quantity map similar thereto and estimates the self-position of the drive-type PJ 20 on the basis of the error. Then, the control unit 31 stores information regarding the estimated self-position (attitude, coordinate position, and the like). It should be noted that Step S105 may be performed simultaneously with Step S102.

[Projection Mode]

(Step S107: Project Geometrically Corrected Video in Arbitrary Direction)

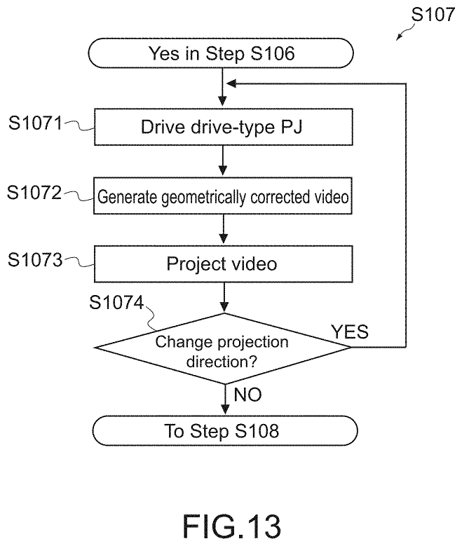

In Step S107, the control unit 31 performs projection control for projecting a geometrically corrected video. FIG. 13 is a flowchart showing in the details of Step S107. Hereinafter, Step S107 will be described with reference to FIG. 13 as appropriate.

On the basis of the output from the overhead camera 224 that has detected the position that the user has pointed for the projection target via the input device 10 (Yes in Step S106), the control unit 31 drives the drive-type PJ 20 to the pointed position (Step S1071). Then, the control unit 31 performs projection control for projecting a geometrically corrected video.

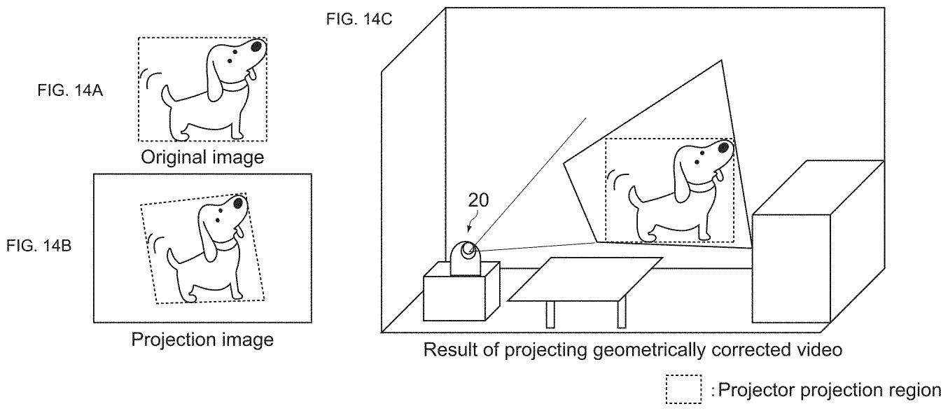

Specifically, as the above-mentioned projection control, the control unit 31 estimates a plane (projection plane) of the projection target on which the video is projected on the basis of angular information of the drive mechanism in a case where the projection direction is directed to the pointed position, the feature quantity map constructed in the previous Step S102 or Step S104, and the information regarding the self-position of the drive-type PJ 20 estimated in the previous Step S105. That is, a degree of distortion of the original image in the projected video (FIG. 14b) is estimated in a case where an original image (FIG. 14a) without geometric correction is projected on the projection target. At this time, the plane is typically estimated from a three-dimensional point group (feature quantity map) in the projection direction, though not limited thereto. Alternatively, a feature quantity map approximated to the plane in advance may be used therefor.

Then, the control unit 31 generates a geometrically corrected video in accordance with the plane of the projection direction on the basis of the estimated plane and the projection direction of the current drive-type PJ 20 (Step S1072) and projects the video (FIG. 14c). Accordingly, the video in which the original image is geometrically corrected (corrected) is projected on the projection target (Step S1073).

FIG. 14 is a diagram showing an example in which the geometric correction is performed in accordance with the plane of the projection direction. In the example shown in FIG. 14, for the sake of convenience of description, the drive-type PJ 20 obliquely projects a video geometrically corrected with respect to the projection plane. In practice, the control unit 31 generates a video geometrically corrected on the basis of the position and normal direction of the projection plane and the current projection direction of the drive-type PJ 20 and the video is projected.

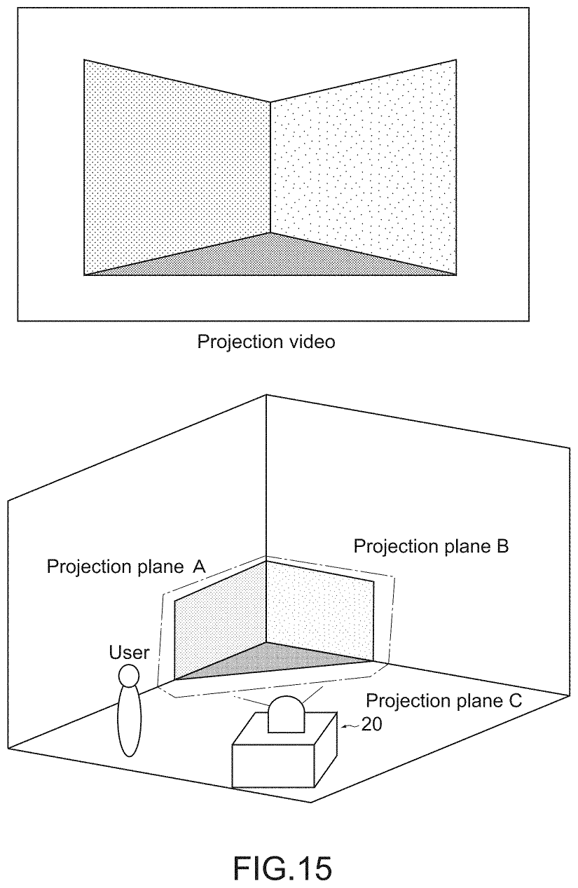

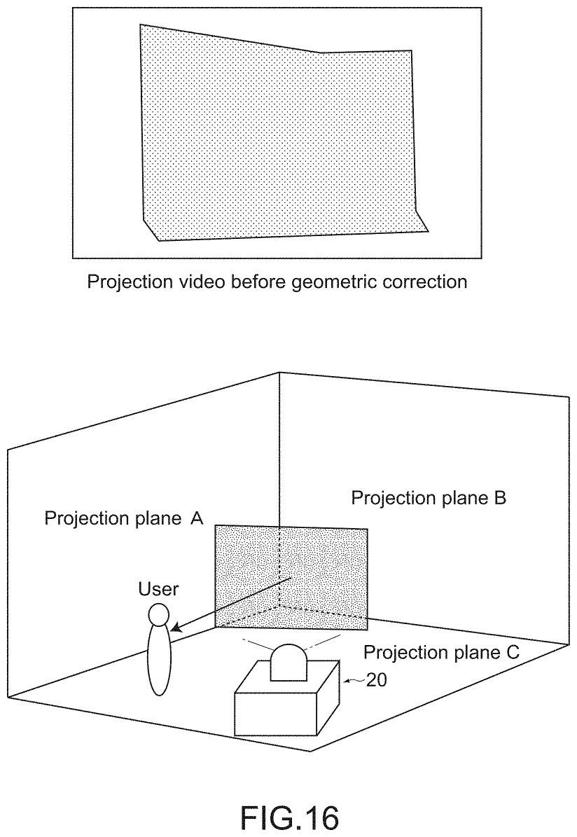

It should be noted that in this embodiment, the geometric correction as described above is typically performed, but in a case where a projection region when the drive-type PJ 20 projects the video extends over a plurality of projection planes, the geometric correction as shown in FIGS. 15 and 16 may be performed.

Here, FIG. 15 shows an example in which among the projection regions on which the video is projected, the projection region, the position, and the normal direction of each projection plane are calculated by the control unit 31 and the video geometrically corrected for each projection plane is projected. In this case, when a plurality of pieces of content (GUIs, gadgets, and the like) project videos through the drive-type PJ 20, a video from each piece of content can be presented on each projection plane.

Moreover, FIG. 16 shows an example in which the video projected by the drive-type PJ 20 is geometrically corrected to appear corrected only to a particular user. In this case, since the video appears distorted from a user at a different position from the position of a target user, it is effective when the user views the content alone in the example shown in FIG. 16.

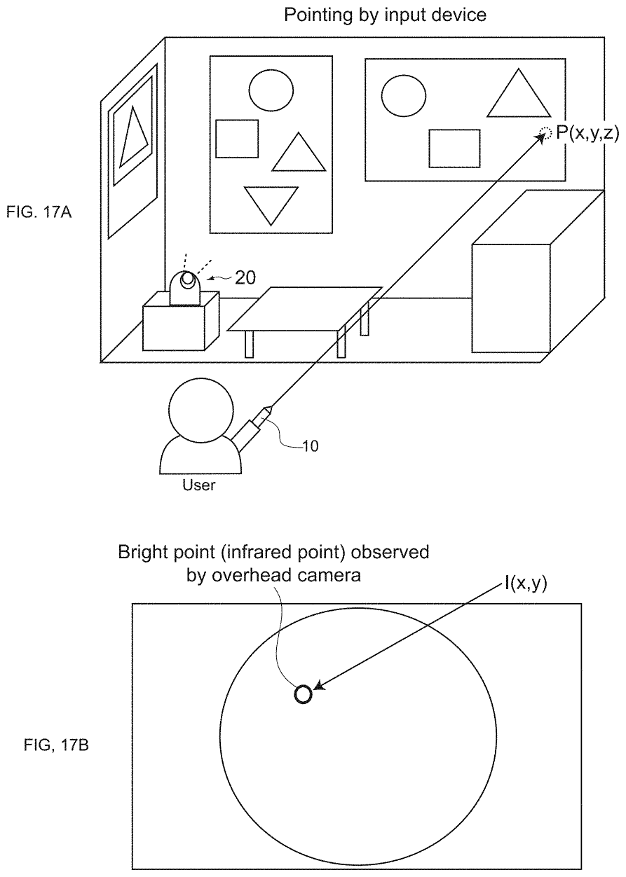

Next, in a case where the user changes the projection direction of the drive-type PJ 20 (YES in Step S1074), the overhead camera 224 built in the drive-type PJ 20 observes a location (infrared point) that the user points via the input device 10 (pointing device), and the three-dimensional position is determined. Specifically, the control unit 31 calculates a three-dimensional coordinate position P (x, y, z) (FIG. 17b) in the real space (feature quantity map) in which the drive-type PJ 20 is set from a two-dimensional coordinate position I (x, y) (FIG. 17a) of a pointing position (infrared point) captured by the overhead camera 224.

Then, the control unit 31 moves the projection direction of the drive-type PJ 20 to the calculated three-dimensional coordinate position P (x, y, z) (Step S1071). On the projection mode according to this embodiment, Step S1071 to Step S1073 are repeated every time the user changes the projection direction of the drive-type PJ 20. That is, the geometrically corrected video is successively projected onto the position following the position (infrared point) pointed by the user via the input device 10.

1-32.) Actions and Effects

The projection system 100 according to this embodiment detects the movement of the drive-type PJ 20 on the standby mode before the video is projected on the projection target, and performs the identification of the real space of the drive-type PJ 20 and the self-position estimation of the drive-type PJ 20 in this real space each time. That is, the identification and the self-position estimation of the real space necessary for projecting the video on the projection target are performed on the standby state.

Accordingly, it is unnecessary to identify the real space or estimate the self-position of the drive-type PJ 20 on the projection mode on which the geometrically corrected video is projected on the projection target. It is thus possible to project the video geometrically corrected immediately when the operation from the user is detected, and the video depending on the projection environment is projected on the projection target without time constraints.

Moreover, in this embodiment, in a case where the feature quantity map of the real space which is the same as the real space in which the feature quantity map is constructed has already been stored, the feature quantity map is updated (Paragraph [0117]). Accordingly, even in a case where there is a difference from the previously constructed feature quantity map due to a region that cannot be observed due to shielding by an object, a change in the arrangement of furniture, or the like, it is possible to improve the accuracy when identifying the real space or estimating the self-position of the drive-type PJ 20 by updating the feature quantity map to the latest feature quantity map.

In particular, in the identification processing (Step S102) and the self-position estimation processing (Step S105) which are performed when the movement of the drive-type PJ 20 is detected in the same real space, updating to the latest feature quantity map makes it unnecessary to observe the entire real space again. As a result, the processing speed is remarkably improved.

It should be noted that the above-mentioned effects are not necessarily limited, and any of the effects shown in the present specification or other effects that can be conceived from the present specification may be achieved in addition to or instead of above-mentioned effects.

### 2.) Another Embodiment

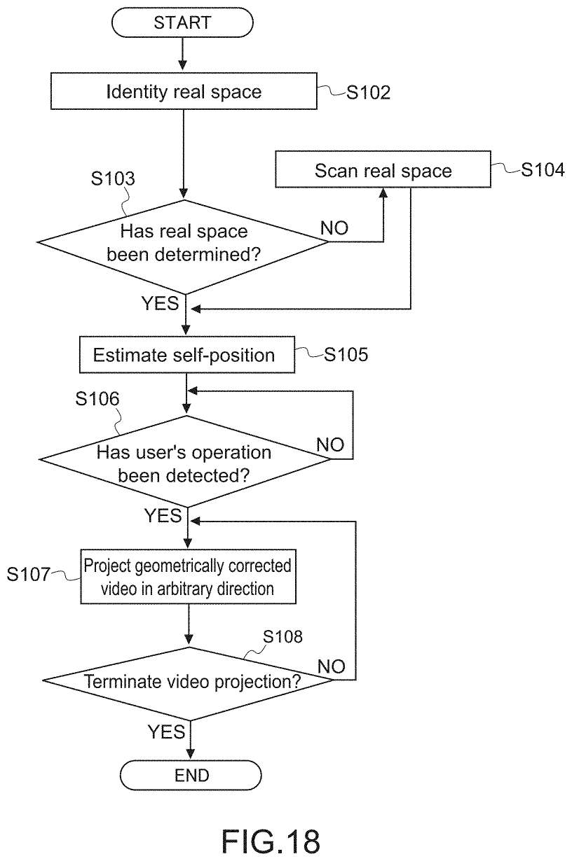

FIG. 18 is a flowchart showing an information processing method according to another embodiment of the present technology. Hereinafter, steps similar to those of the first embodiment will be denoted by the same reference signs and descriptions thereof will be omitted.

In the other embodiment of the present technology, the processing shown in FIG. 18 is performed when the projection system 100 is activated (powered on). That is, the second embodiment differs from the first embodiment in that Step S101 described above is omitted.

### 3.) Modified Examples

Although the embodiments of the present technology have been described above, the present technology is not limited to the embodiments described above, and various modifications can be made as a matter of course.

For example, in the above-mentioned embodiments, the depth sensor 227 is used for measuring the three-dimensional shape of the real space, though not limited thereto. Alternatively, the three-dimensional shape of the real space may be measured by stereo matching using the radar distance measurement sensor 228 and a plurality of cameras, for example.

Moreover, in the above-mentioned embodiments, the position pointed through the input device 10 is detected by the overhead camera 224, though not limited thereto. For example, a combined sensor including the overhead camera 224 and a gaze sensor having a narrower viewing angle than the wide-angle cameras constituting the overhead camera 224 may detect the position pointed through the input device 10. Accordingly, it is possible to sense the position pointed with higher accuracy than using only the overhead camera 224, and it is possible to ensure sufficient detection accuracy in detecting the position pointed through the input device 10.

Furthermore, in the above-mentioned embodiments, any of the various sensors constituting the sensor group 20 is a device disposed coaxially with the projection direction of the projector 211 and is driven by the drive mechanism 23 simultaneously with the projector 211, though not limited thereto. Alternatively, the projector 211 and the sensor group 22 may be disposed at different positions when the projector 211 and the sensor group 22 are built in the drive-type PJ 20.

In addition, in the above-mentioned embodiments, the movement of the drive-type PJ 20 is detected by the geomagnetic sensor 222, the acceleration sensor 225, or the gyro sensor 226, though not limited thereto. Alternatively, it may be determined whether or not the drive-type PJ 20 has moved depending on whether or not there is a deviation between the feature quantity map referred to when estimating the self-position of the drive-type PJ 20 and the feature quantity map of the real space in which the drive-type PJ 20 is currently set. Moreover, all sensors of the three types of sensors of the geomagnetic sensor 222, the acceleration sensor 225, and the gyro sensor 226 do not necessarily need to be used for detecting the movement of the drive-type PJ 20, one or two of the three sensors may be omitted depending on needs as long as the movement of the drive-type PJ 20 can be detected.

Moreover, in the above-mentioned embodiments, the user's operation is detected by detecting the position, which the user points via the input device 10, by the overhead camera 224, though not limited thereto. Alternatively, the user's operation may be detected in such a manner that the user has the input device 10 provided with the IMU sensor (inertial measuring device).

Moreover, in the above-mentioned embodiments, the real space may be identified on the basis of whether or not the difference between the space size of the real space that has already been identified and the space size of the real space in which the drive-type PJ 20 is currently set is equal to or less than a predetermined threshold value.

In addition, in the above Step S102, the real space is identified on the basis of whether or not the reprojection error is equal to or less than the predetermined threshold value, though not limited thereto. Alternatively, in a case where the real space that has already been identified is associated with the ID, the user may refer to a real space ID list displayed via the output apparatus 39 and select the real space in which the drive-type PJ 20 is currently set from the list for identifying the real space. In a case where no real spaces are associated with the real space ID list, it may be concluded that the real space fails to be identified.

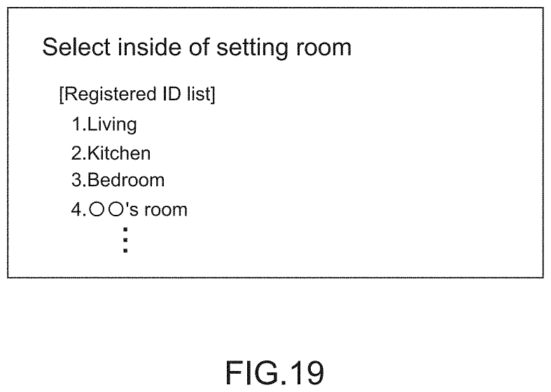

FIG. 19 is a diagram showing an example of the real space ID list. In FIG. 19, only the ID of the real space is displayed, though not limited thereto. Alternatively, for example, a registered feature quantity map (three-dimensional space map) of the real space may also be displayed on the output apparatus 39 together with a real space ID.

Moreover, in the above-mentioned embodiments, the feature quantity map is updated in Step S102, though not limited thereto. Alternatively, the feature quantity map may be updated after Step S102 or Step S105, for example, in a case where the user determines the projection direction (Step S107). Accordingly, the feature quantity of a projection portion desired by the user is locally updated. Alternatively, the feature quantity map may be updated when the user is not in the real space by recognizing whether or not the user is in the real space, or the feature quantity map may be updated at predetermined intervals or at a predetermined time zone such as a midnight zone.

Moreover, in the above-mentioned embodiments, the user may be individually identified and the user's use of the drive-type PJ 20 may be restricted depending on the location where the drive-type PJ 20 is used. As a specific use case, a case where when the user brings the drive-type PJ 20 into a particular room, only the user who mainly uses the room can use the drive-type PJ 20 or the like while all family members can use the drive-type PJ 20 in a real space such as a living room and a dining where the family members gather is conceivable, for example.

In addition, in the above-mentioned embodiments, it is assumed that the single drive-type PJ 20 is used, though not limited thereto. Alternatively, the projection system 100 according to the present technology may include a plurality of drive-type PJs 20. Accordingly, for example, the current feature quantity map can be obtained from the previously set drive-type PJ 20 by cooperation of the drive-type PJs 20. Moreover, by causing each of the plurality of drive-type PJ 20 to cooperate, it is possible to quickly construct and update the feature quantity map of the real space in which the drive-type PJ 20 is currently set.

Moreover, in the above-mentioned embodiments, geometric correction is performed as the projection control performed by the control unit 31, though not limited thereto. Alternatively, for example, color correction depending on the color or brightness of the projection target may be performed instead of or in addition to the geometric correction.

### 4.) Supplement

Embodiments of the present technology can include, for example, the information processing apparatus as described above, the system, the information processing method performed by the information processing apparatus or the system, a program for causing the information processing apparatus to function, and a non-temporary tangible medium in which a program is recorded.

Moreover, it is assumed that the projection system 100 according to this embodiment is mainly used in a room such as a living room, a kitchen, and a bedroom, though not limited thereto. The application of the present technology is not particularly limited. For example, the projection system 100 may be used in a vehicle such as a car or a room such as a conference room. In this case, a use case where the drive-type PJ 20 is set in the vehicle or the conference room and content is viewed at an arbitrary location is conceivable, for example. Moreover, the projection system 100 may be used as an item of attraction with a larger spatial scale, such as a theme park. In this case, since a room can be determined (identified) in the projection system 100 according to the present technology, various types of content will be presented for each room.

In addition, the effects described herein are illustrative or exemplary only and not limitative. That is, the present technology may have other effects apparent to those skilled in the art from the description of the present specification in addition to or instead of the above-mentioned effects.

Although favorable embodiments of the present technology have been described above in detail with reference to the accompanying drawings, the present technology is not limited to such examples. It is obvious that a person ordinarily skilled in the art may conceive various variants or modifications within the scope of the technical idea defined in the scope of claims and it should be understood that those are also encompassed in the technical scope of the present technology as a matter of course.

It should be noted that the present technology may also take the following configurations.

(1) An information processing apparatus, including

a control unit that estimates a self-position of a projection apparatus in a real space in accordance with a movement of the projection apparatus and performs projection control of the projection apparatus on the basis of at least the estimated self-position.

(2) The information processing apparatus according to (1), in which

the control unit acquires space information of the real space and performs the projection control on the basis of the space information and the estimated self-position.

(3) The information processing apparatus according to (2), in which

the control unit estimates the self-position of the projection apparatus on the basis of the space information.

(4) The information processing apparatus according to (2) or (3), in which

the control unit calculates a feature quantity of the real space on the basis of the space information and estimates the self-position of the projection apparatus on the basis of the feature quantity.

(5) The information processing apparatus according to (4), in which

the control unit performs the projection control on the basis of the feature quantity and the estimated self-position.

(6) The information processing apparatus according to any one of (2) to (5), in which

the control unit identifies a type of the real space on the basis of the space information.

(7) The information processing apparatus according to any one of (2) to (6), in which

the control unit calculates the feature quantity of the real space on the basis of the space information and identifies the real space on the basis of the feature quantity.

(8) The information processing apparatus according to any one of (4), (5), and (7), in which

the control unit calculates a reprojection error on the basis of the feature quantity and identifies the real space in a case where the reprojection error is equal to or less than a predetermined threshold.

(9) The information processing apparatus according to any one of (2) to (8), in which

the control unit newly acquires the space information of the real space by scanning the real space by the projection apparatus in a case where the type of the real space can be identified.

(10) The information processing apparatus according to (9), in which

the control unit estimates the self-position of the projection apparatus on the basis of the newly acquired space information.

(11) The information processing apparatus according to (9) or (10), in which

the control unit performs the projection control on the basis of the newly acquired space information and the estimated self-position.

(12) The information processing apparatus according to any one of (4), (5), (7), and (8), in which

the control unit acquires shape data regarding a three-dimensional shape of the real space and calculates the feature quantity on the basis of at least the shape data.

(13) The information processing apparatus according to any one of (4), (5), (7), (8), and (12), in which

the control unit calculates a two-dimensional feature quantity, a three-dimensional feature quantity, or a space size of the real space as the feature quantity.

(14) The information processing apparatus according to any one of (1) to (13), in which

the control unit performs a standby mode to identify the type of the real space and estimate the self-position of the projection apparatus.

(15) The information processing apparatus according to any one of (1) to (14), in which

the control unit includes generates a geometrically corrected video as the projection control.

(16) The information processing apparatus according to (15), in which

the control unit causes the projection apparatus to project the geometrically corrected video to a position specified by a user.

(17) An information processing method, including:

by an information processing apparatus

estimating a self-position of a projection apparatus in a real space in accordance with a movement of the projection apparatus; and

performing projection control of the projection apparatus on the basis of at least the estimated self-position.

(18) A program that causes an information processing apparatus to execute:

a step of estimating a self-position of a projection apparatus in a real space in accordance with a movement of the projection apparatus; and

a step of performing projection control of the projection apparatus on the basis of at least the estimated self-position.

(19) A computer-readable recording medium recording the program according to (18).

(20) A projection system, including:

a projection apparatus that projects a video to a projection target; and

an information processing apparatus including a control unit that estimates a self-position of a projection apparatus in a real space in accordance with a movement of the projection apparatus and performs projection control of the projection apparatus on the basis of at least the estimated self-position.
20 drive-type PJ (projection apparatus)
30 information processing apparatus
31 control unit
100 projection system

1. An information processing apparatus, comprising
a control unit that estimates a self-position of a projection apparatus in a real space in accordance with a movement of the projection apparatus and performs projection control of the projection apparatus on a basis of at least the estimated self-position.

2. The information processing apparatus according to claim 1, wherein
the control unit acquires space information of the real space and performs the projection control on a basis of the space information and the estimated self-position.

3. The information processing apparatus according to claim 2, wherein
the control unit estimates the self-position of the projection apparatus on a basis of the space information.

4. The information processing apparatus according to claim 3, wherein
the control unit calculates a feature quantity of the real space on a basis of the space information and estimates the self-position of the projection apparatus on a basis of the feature quantity.

5. The information processing apparatus according to claim 4, wherein
the control unit performs the projection control on a basis of the feature quantity and the estimated self-position.

6. The information processing apparatus according to claim 2, wherein
the control unit identifies a type of the real space on a basis of the space information.

7. The information processing apparatus according to claim 6, wherein
the control unit calculates the feature quantity of the real space on a basis of the space information and identifies the real space on a basis of the feature quantity.

8. The information processing apparatus according to claim 7, wherein
the control unit calculates a reprojection error on a basis of the feature quantity and identifies the real space in a case where the reprojection error is equal to or less than a predetermined threshold.

9. The information processing apparatus according to claim 6, wherein
the control unit newly acquires the space information of the real space by scanning the real space by the projection apparatus in a case where the type of the real space can be identified.

10. The information processing apparatus according to claim 9, wherein
the control unit estimates the self-position of the projection apparatus on a basis of the newly acquired space information.

11. The information processing apparatus according to claim 10, wherein
the control unit performs the projection control on a basis of the newly acquired space information and the estimated self-position.

12. The information processing apparatus according to claim 4, wherein
the control unit acquires shape data regarding a three-dimensional shape of the real space and calculates the feature quantity on a basis of at least the shape data.

13. The information processing apparatus according to claim 12, wherein
the control unit calculates a two-dimensional feature quantity, a three-dimensional feature quantity, or a space size of the real space as the feature quantity.

14. The information processing apparatus according to claim 6, wherein
the control unit performs a standby mode to identify the type of the real space and estimate the self-position of the projection apparatus.

15. The information processing apparatus according to claim 1, wherein
the control unit includes generates a geometrically corrected video as the projection control.

16. The information processing apparatus according to claim 15, wherein
the control unit causes the projection apparatus to project the geometrically corrected video to a position specified by a user.

17. An information processing method, comprising:
by an information processing apparatus
estimating a self-position of a projection apparatus in a real space in accordance with a movement of the projection apparatus; and
performing projection control of the projection apparatus on a basis of at least the estimated self-position.

18. A program that causes an information processing apparatus to execute:
a step of estimating a self-position of a projection apparatus in a real space in accordance with a movement of the projection apparatus; and
a step of performing projection control of the projection apparatus on a basis of at least the estimated self-position.

19. A computer-readable recording medium recording the program according to claim 18.

20. A projection system, comprising:
a projection apparatus that projects a video to a projection target; and
an information processing apparatus including a control unit that estimates a self-position of a projection apparatus in a real space in accordance with a movement of the projection apparatus and performs projection control of the projection apparatus on a basis of at least the estimated self-position.
